(19) United States
(12) Patent Application Publication
(10) Pub. No.: US 2005/0279088 A1
(43) Pub. Date: Dec. 22, 2005

(54) Emergency control method for work device in construction equipment

(75) Inventor: Dong Soo Kim, Changwon (KR)

Correspondence Address: Ladas & Parry, 26 West 61st Street, New York, NY, 10023, US

(73) Assignee: VOLVO CONSTRUCTION EQUIPMENT HOLDING SWEDEN AB

(21) Appl. No.: 10/890,738

(22) Filed: Jul. 14, 2004

(30) Foreign Application Priority Data
Mar. 10, 2004 (KR) 10-2004-0016076

(51) Int. Cl. F16D 31/02

(52) U.S. Cl. 60/449

(57) ABSTRACT

In the case an unexpected problem occurs in a power supply source like an engine during construction work using heavy equipment like an excavator, a emergency control method for work device of construction equipment of the present invention can be advantageously used for preventing a fall of the work device and ensuring a safe landing of the work device by driving a direction switching valve using the hydraulic pressure accumulated in an accumulator or an electric force. The control method preferably includes the steps of: determining a state of the engine; if the engine is in off state despite the absence of an engine off request signal, determining that the engine is stopped abnormally; and if the engine is stopped abnormally, outputting a control signal to the valve driving units in correspondence to the control input of the operation lever.

### BACKGROUND OF THE INVENTION

1. Field of the Invention

The present invention relates in general to a emergency control method for work device in construction equipment, wherein if there is an unexpected error in a power supply source (e.g., an engine) during excavating or loading by using heavy equipment like an excavator, the work device like a boom can be landed safely on the ground.

More specifically, the present invention relates to a emergency control method for work device of construction equipment, wherein if an engine stops during working of the work device and thus hydraulic fluid is no more supplied to the work device, the work device (e.g., a boom) in operation does not automatically fall because of its weight but can be landed safely on the ground by driving a direction switching valve using hydraulic pressure stored in an accumulator or using an electric force.

2. Description of the Related Art

In general, an actuator (e.g., a boom cylinder) for use in heavy equipment like an excavator in excavating and loading, and an actuator (e.g., a driving motor) for driving are driven by hydraulic fluid discharged from a hydraulic pump connected to an engine.

When a driver operates a corresponding operation lever for driving work devices like a boom, an arm, and a bucket in order to excavate or load, a driver is sometimes faced with an unexpected situation during working of the work device. That is, sometimes power supply to the engine ECU is blocked or a communication failure occurs or the engine suddenly stops due to fuel leakage, or the hydraulic pump connected to the engine would not operate. In these cases, hydraulic fluid for driving the work devices is no longer supplied to the actuators and thus, the work itself has to be stopped.

At this time, if the boom is up and a load has been applied to the boom cylinder and especially if the ground in this situation is not even, the boom cylinder is constricted to such a degree by weights of the boom and the bucket, and eventually the boom and the bucket fall down toward the ground contrary to the driver's will, thereby causing an accident unexpectedly.

### SUMMARY OF THE INVENTION

It is, therefore, an object of the present invention to provide a emergency control method for work device of construction equipment, wherein if an unexpected error occurs to a power supply source like an engine during working of the work device, the work device like a boom in operation does not fall because of its weight but can be landed safely on the ground by driving a direction switching valve using hydraulic pressure stored in an accumulator or using an electric force, whereby damages on the construction equipment and physical injuries of drivers caused by a fall of the work device can be prevented.

To achieve the above object, there is provided a emergency control method for work device of construction equipment mounted with an engine; a hydraulic pump connected to the engine; an actuator connected to the hydraulic pump; a direction switching valve installed in a hydraulic path between the hydraulic pump and the actuator, and for controlling start-up or stoppage, and direction change of the actuator; an operation lever driven by a driver and for generating a driving signal of the work device; a controller for receiving an operational signal of the operation lever and operating control input of the operation lever, and outputting a control signal to switch the direction switching valve; and valve driving units for driving the direction switching valve, according to the control signal outputted from the controller, the control method including the steps of: determining whether the RPM of the engine is lower than a predetermined RPM, thereby determining a state of the engine; if the engine is in off state despite the absence of an engine off request signal, determining that the engine is stopped abnormally; and if the engine is stopped abnormally, outputting a control signal to the valve driving units in correspondence to the control input of the operation lever.

According to a preferred embodiment of the present invention, if the engine is stopped abnormally, the controller informs to the driver about the abnormal stoppage of the engine through a dashboard or by generating an alarm.

### BRIEF DESCRIPTION OF THE DRAWINGS

The above objects, features and advantages of the present invention will become more apparent from the following detailed description when taken in conjunction with the accompanying drawings, in which:

FIG. 1 is a flow chart describing a emergency control method for work device of construction equipment according to the present invention; and

FIG. 2 is a schematic diagram of a control circuit in a work device to which the present invention is applied.

### DETAILED DESCRIPTION OF THE PREFERRED EMBODIMENT

A preferred embodiment of the present invention will be described herein below with reference to the accompanying drawings. The preferred embodiment of the present invention is nothing but the one provided to assist in a comprehensive understanding of the invention. Thus, it is apparent that the technical idea and the scope of the present invention can not be limited by the preferred embodiment of the present invention. In the following description, well-known functions or constructions are not described in detail since they would obscure the invention in unnecessary detail.

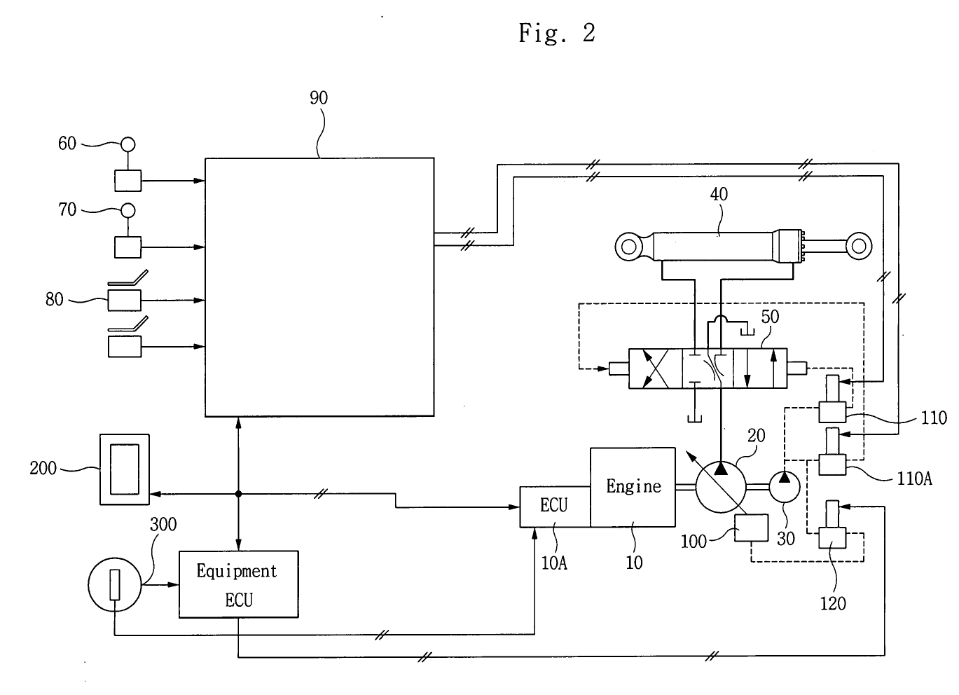

As shown in FIG. 2, construction equipment to which the present invention is applied includes an engine 10, first and second hydraulic pumps 20 and 30, an actuator 40, a direction switching valve 50, operation levers 60, 70, a controller 90, and valve driving units 110, 110A and 120.

The first and second hydraulic pumps 20 and 30 are connected to the engine 10, and the first hydraulic pump 20 is connected to actuator 40. Also, the direction switching valve 50 is installed in a hydraulic path between the first hydraulic pump 20 and the actuator 40, and controls start-up or stoppage, and direction change of the actuator 40. Here, the swash plate of the first hydraulic pump 20 is controlled by a regulator 100, and the regulator 100 operates in response to a control signal from the valve driving units 110, 110A, and 120.

The operation levers 60, 70, and 80 are operated by the driver and each operation lever generates a driving signal. Then the controller 90 receives the driving signal from the operation levers 60, 70, and 80, operates control input thereof, and outputs a control signal for switching the direction switching valve 50.

The valve driving units (i.e. EPPRV) 110 and 110A are installed between the second hydraulic pump 30 and the direction switching valve 50, and each outputs the control signal from the controller 90 to the direction switching valve 50. In addition, an accumulator (not shown) is installed in a discharge hydraulic path of the second hydraulic pump 30.

Since techniques associated with the elements described above are well known to people skilled in the art, no details will be provided on their structures and operations.

The following will now explain in more detail the emergency control method for work device of construction equipment according to the present invention.
I) In the case the engine 10 and the first and second hydraulic pumps 20 and 30 are in normal operation

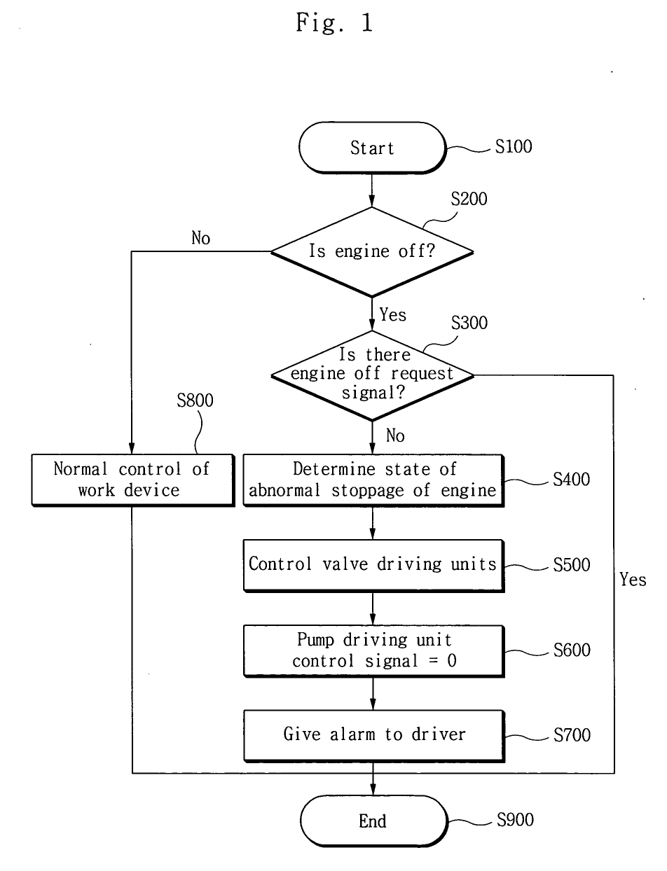

As described in FIG. 1, when the driver operates the operation lever 60 for use in boom control, the controller 90 receives through A/D conversion the control input of the operation lever 60, and operates a control signal of the direction switching valve 50 and the valve driving units 110, 110A, and 120, respectively, in response to the control input, and then outputs a current value corresponding to a value of the operation.

Each of the valve driving units 110, 110A, and 120 is composed of an EPPR valve whose pressure increases in proportion to a current value being inputted. Therefore, the valve driving units 110 and 110A receive a control signal outputted from the controller 90 and then drive the direction switching valve 50, whereby a designated amount of hydraulic fluid is supplied to the actuator 40 to drive the work device, while the valve driving unit 120 drives the regulator 100 and controls the swash plate of the first hydraulic pump 20.

As the hydraulic fluid discharged from the first hydraulic pump 20 is supplied to a large chamber of the actuator 40 via the direction switching valve 50, the work device like a boom starts operating, such as leveling the ground or loading.

On the other hand, part of the hydraulic fluid discharged from the second hydraulic pump 30 fills up the accumulator (not shown) within a designated pressure range.
II) In the case the engine 10 and the first and second hydraulic pumps 20 and 30 suddenly stop operating because of an unexpected reason during working of the work device.

When the driver operates the operation lever, a driving signal (or operational signal) from the operation lever is inputted to the controller 90 through A/D conversion. And, the engine RPM is inputted from an engine ECU 10 to the controller 90 through a communication line.

Moreover, as part of obtaining corresponding data, the controller 90 receives an engine off signal from an ignition switch 300 or receives a message from the engine 10 through the communication line, the message informing that the engine is turned off. It is supposed that the engine is operating normally during working of the work device.

If the engine RPM is lower than a predetermined RPM, the controller determines that the engine 10 has been stopped (S200).

If the engine 10 is off, the controller determines whether there has been an engine off request signal (S300).

If it turns out that there was no engine off request signal, the controller regards that the engine 10 has been stopped not in a proper way (S400).

Next, the controller operates the (drive) input of the direction switching valve 50, in response to the control input by the driver to the operation lever, and outputs it to the valve driving units 110 and 110A (S500).

Since hydraulic power supply from the first hydraulic pump 20 to the actuator is cut off, control signal output is also blocked to reserve the hydraulic pressure accumulated in the accumulator (S600).

Lastly, the controller shows on a dashboard that the engine 10 has been stopped not in a proper way or generates an alarm to inform the driver the abnormal stoppage of the engine (S700).

Therefore, even though the engine 10 is suddenly turned off during working of the work device, the controller 90 outputs a control signal to drive the valve driving units 110 and 110A, and switches the direction switching valve 50 by utilizing the hydraulic fluid kept in the accumulator. When the direction switching valve 50 is switched, a return hydraulic path is opened and the work device is landed safely on the ground.

In conclusion, the emergency control method for work device of construction equipment according to the present invention has the following advantages:

Although the power supply source like the engine has a problem all of sudden, the work device in operation does not fall by its weight but can be landed safety on the ground by driving the direction switching valve using the hydraulic pressure accumulated in the accumulator or an electric force. In this manner, it is possible to prevent damages on the construction equipment and injuries on people caused by the sudden fall of the work device and thus, the reliability of the construction equipment can be improved.

While the invention has been described in conjunction with various embodiments, they are illustrative only. Accordingly, many alternative, modifications and variations will be apparent to persons skilled in the art in light of the foregoing detailed description. The foregoing description is intended to embrace all such alternatives and variations falling with the spirit and broad scope of the appended claims.

1. A emergency control method for work device of construction equipment mounted with an engine; a hydraulic pump connected to the engine; an actuator connected to the hydraulic pump; a direction switching valve installed in a hydraulic path between the hydraulic pump and the actuator, and for controlling start-up or stoppage, and direction change of the actuator; an operation lever driven by a driver and for generating a driving signal of the work device; a controller for receiving an operational signal of the operation lever and operating control input of the operation lever, and outputting a control signal to switch the direction switching valve; and valve driving units for driving the direction switching valve, according to the control signal outputted from the controller, the control method comprising the steps of:
determining whether the RPM of the engine is lower than a predetermined RPM, thereby determining a state of the engine;
if the engine is in off state despite the absence of an engine off request signal, determining that the engine is stopped abnormally; and
if the engine is stopped abnormally, outputting a control signal to the valve driving units in correspondence to the control input of the operation lever.

2. The control method according to claim 1, wherein if the engine is stopped abnormally, informing to the driver about the abnormal stoppage of the engine through a dashboard or an alarm.
